(19) United States
(12) Patent Application Publication
(10) Pub. No.: US 2007/0127967 A1
(43) Pub. Date: Jun. 7, 2007

(54) Image forming apparatus

(75) Inventor: Yukihiro Sasao, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/606,338

(22) Filed: Nov. 30, 2006

(30) Foreign Application Priority Data
Dec. 1, 2005 (JP) 2005-347529

(51) Int. Cl. B41J 19/30

(52) U.S. Cl. 400/323

(57) ABSTRACT

A memory 8 stores integral gain values Ki and differences Δ between an actual stop position and a target stop position of the carrier 41 so as to corresponding to each other. A controller 7 calculates each difference between the actual stop position and the target stop position of the carrier 41 which is detected through an encoder 50, and then controls a carrier drive motor 42 with referring an appropriate integral gain value in the integral gain values stored in the memory 8. Consequently, the carrier drive motor 42 can be controlled at the integral gain value Ki which always minimizes the difference between the actual stop position and the target stop position of the carrier 41, and the accuracy of the stop position of the carrier can be enhanced with using an inexpensive DC motor for the carrier drive motor 42.

### BACKGROUND OF THE INVENTION

1. Field of the Invention

The present invention relates to an image forming apparatus which drives a carrier with holding ink cartridges thereon in a main scanning direction with a DC motor, and forms an image on a recording paper sheet by discharging ink drops from a recording head on the carrier to the recording paper sheet.

2. Description of the Related Art

In a conventional ink jet printer which is an example of an image forming apparatus, ink drops are discharged from a recording head to a recording paper sheet which is conveyed in a predetermined direction (sub-scanning direction) while ink cartridges are reciprocally carried with a carrier in a main scanning direction perpendicular to the predetermined direction, so that an image is formed on the recording paper sheet. Therefore, if the stop position of the carrier in the main scanning direction varies in each reciprocation movement, it may cause the discrepancy between the timing of discharge of the ink drops and the position of the carrier, and thereby, causes the degradation of the print quality.

By the way, a DC (direct current) motor is widely used for driving the carrier of the ink jet printer recently, so as to reduce the manufacturing cost. Although the DC motor is inexpensive, it cannot control the position of the carrier by itself like a step motor does. Thus, when using the DC motor for driving the carrier, an encoder to detect the position of the carrier is used together with it.

Japanese Laid-Open Patent Publication No. 2004-181828 discloses a conventional ink jet printer in which a debasement of detection accuracy in a position of a carrier due to an error in an installation position of an optical sensor on the carrier is prevented. Japanese Laid-Open Patent Publication No. 2004-174984 discloses another conventional ink jet printer in which a drive mode of a carrier is selected and then an encoder signal used for a feedback control of the carrier is selected in response to the selected drive mode. Japanese Laid-Open Patent Publication No. 2002-250637 discloses still another conventional ink jet printer in which a reference position of a carrier is detected by forming a solid black area without a slit on a scale of a linear encoder.

The stop position of the carrier is generally associated with weights of the ink cartridges, and it changes according to a remaining amount of inks. In particular, the ink cartridge which is almost empty weighs approximately sixty percent of the new ink cartridge, so that the carrier stops short of its target stop position. Moreover, the stop position of the carrier also varies according to an individual difference among drive systems for transmitting a drive power of the DC motor to the carrier, or an individual difference among torque characteristics of the DC motors. Consequently, the print quality depends of the accuracy of the stop position of the carrier.

### SUMMARY OF THE INVENTION

The present invention is to solve the problem described above, and an object of the present invention is to provide an image forming apparatus, which improves a print quality by enhancing an accuracy of stop position of a carrier regardless of a remaining amount of inks and so on, at low cost.

An image forming apparatus in accordance with an aspect of the present invention comprises: a carrier which holds at least one ink cartridge and reciprocally moves in a first direction; a conveyor for conveying a recording paper sheet in a second direction perpendicular to the first direction; a recording head provided on the carrier or the ink cartridge for discharging ink drops of an ink stored in the ink cartridge toward the recording paper sheet conveyed in the second direction to form an image on the recording paper sheet while the carrier with the ink cartridge is reciprocally moved in the first direction; a DC motor which drives the carrier so as to reciprocally move in the first direction; a drive transmission mechanism which transmits a drive force of the DC motor to the carrier; an encoder which detects a position of the carrier driven in the first direction; a controller which controls the DC motor based on signals outputted from the encoder; and a memory which stores parameters referred when the motor control means controls the DC motor.

The controller detects an actual stop position of the carrier based on the signals outputted from the encoder, calculates a difference between the actual stop position and a target stop position of the carrier, and varies a parameter, which is used for controlling the DC motor, according to the difference, and thereby, stopping the carrier substantially at the target stop position.

According to such a constitution, even when the ink filled in the ink cartridge is consumed and the weight of the carrier is varied, the controller varies the parameter used for controlling the DC motor according to the difference between the actual stop position and the target stop position of the carrier. Thus, the difference between the actual stop position and the target stop position of the carrier is minimized, and thereby, the carrier can be stopped substantially at the target stop position. Consequently, the print quality of the image formed on the recording paper sheet is not deteriorated, although the inexpensive DC motor us used for driving the carrier.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the attached drawings. It is to be noted that all the drawings are shown for the purpose of illustrating the technical concept of the present invention or embodiments thereof, wherein:

FIG. 1 is a sectional view showing a schematic configuration of an ink jet printer in accordance with a preferred embodiment of the present invention;

FIG. 2 is a side view showing a configuration in a vicinity of a carrier of the ink jet printer;

FIG. 3 is an explanatory drawing showing a difference between an actual stop position and a target stop position of the carrier when remaining ink in an ink cartridge is small in amount;

FIG. 4 is a table showing a relationship between each integral gain value and each difference between the actual stop position and the target stop position of the carrier; and

FIG. 5 is a flowchart showing a process in a controller of the ink jet printer when the integral gain value is changed.

### DESCRIPTION OF THE PREFERRED EMBODIMENTS

An ink jet printer as an example of an image forming apparatus in accordance with a preferred embodiment of the present invention is described with reference to the attached drawings.

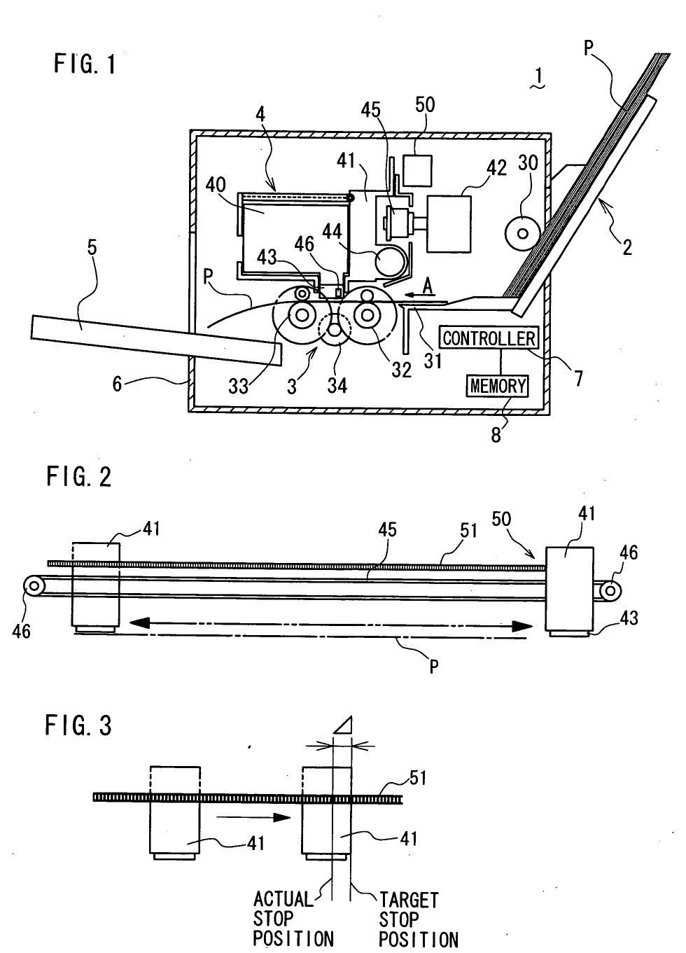

FIG. 1 shows a schematic configuration of the ink jet printer 1. The ink jet printer 1 comprises a paper feed tray 2 on which recording paper sheets P are loaded, a conveyor 3 which conveys the recording paper sheet P held on the paper feed tray 2 into an inside of the ink jet printer 1, an image forming unit 4 which forms an image on the recording paper sheet P conveyed by the conveyor 3, an exit tray 5 on which the recording paper sheets P, each having the image formed through the image forming unit 4, are piled up, a housing 6 which houses the conveyor 3 and the image forming unit 4, a controller (serving as a carrier drive motor control means, a carrier position detecting means, and a difference calculation means) 7 which controls the conveyor 3 and the image forming unit 4, a memory 8 which stores a parameter referred when the controller 7 controls the conveyor 3 and the image forming unit 4, and so on.

The conveyor 3 comprises a pick up roller 30 which picks up a recording paper sheet P piled at the top on the paper feed tray 2 and conveys the picked recording paper sheet P into the inside of the housing 6, a bottom guide member 31 which guides a front edge and an underside of the recording paper sheet P conveyed by the pick up roller 30, and then leads the recording paper sheet P to a paper feeding roller 32, the paper feeding roller 32 which is placed in an upstream portion in a paper conveying path from the image forming unit 4 and conveys the recording paper sheet P to the image forming unit 4, a paper ejection roller 33 to eject the recording paper sheet P on which an image is formed through the image forming unit 4, a feed motor 34 to drive the pick up roller 30, the paper feeding roller 32, and the paper ejection roller 33, and so on.

The image forming unit 4 comprises an ink cartridge or ink cartridges 40 each of which is filled with an ink or inks, a carrier 41 which holds the ink cartridge or ink cartridges 40 and also moves reciprocally in a main scanning direction (first direction) perpendicular to the paper conveying direction (second direction) A of the recording paper sheet P, a carrier drive motor 42 which drives the carrier 41, a driving transmission mechanism, and so on. The paper conveying direction A is called sub-scanning direction. In this embodiment, a recording head 43 which discharges ink drops toward the recording paper sheet P is provided on a bottom surface of each ink cartridge 40. A shaft 44, which is disposed in parallel with the main scanning direction, holds the carrier 41 so as to move reciprocally. The carrier drive motor 42 drives the carrier 41 to move reciprocally in the main scanning direction along the shaft 44. A driving force of the carrier drive motor 42 is transmitted to the carrier 41 through a belt 45. In this embodiment, the print head 43 is placed on the ink cartridge 40, thus the print head 43 is replaced with a new one every time the ink cartridge 40 is replaced with a new one. Consequently, for a long-term use, the ink jet printer 1 can form a higher quality of image than that of an ordinary ink jet printer having the print head 43 on the carrier 41 forms. Furthermore, in this embodiment, an inexpensive DC (direct current) motor is applied to the carrier drive motor 42, and a position of the carrier 41 is detected by an encoder 50 which is placed along a motion space of the carrier 41.

FIG. 2 shows a configuration in the vicinity of the carrier 41. The drive transmission mechanism is comprised of two pulleys 46 and a belt 45 hanged between the pulleys 46 one of which is connected to the carrier drive motor 42, and thereby, the drive force of the carrier drive motor 42 is transmitted to the carrier 41 through the pulleys 46 and the belt 45 sequentially. The encoder 50 comprises a grid plate 51 in which a striped pattern is formed in the main scanning direction at a predetermined interval, a photo interrupter which is placed on a back surface of the carrier 41 (not shown), and so on. The photo interrupter has a light emitter which irradiates a light on the grid plate 51 and a light receiver which receives the light, which passes through the grid plate 51 or is reflected by the grid plate 51, and converts the light energy into an electronic signal. In the grid plate 51, the striped pattern is formed at the predetermined interval, so that pulse signals corresponding to the striped pattern described above are outputted from the light receiver in the encoder 50 corresponding to the movement of the carrier 41. The controller 7 detects the position of the carrier 41 on the basis of a number of the pulse signals which are outputted from the encoder 50.

In the ink jet printer 1, the image is formed on the recording paper sheet P, which is conveyed in the sub-scanning direction, by discharging ink drops from the print head 43 while the carrier 41 is reciprocally moved in the main scanning direction. Therefore, in order to obtain a fine print quality, it is necessary to control of the carrier drive motor 42 to stop the carrier 41 at a target stop position, precisely. However, as described above, the stop position of the carrier 41 varies according to the remaining amount of the inks in the ink cartridge or ink cartridges 40, and so on, and thereby, the variation of the stop position of the carrier 41 causes the deterioration of the print quality. Thus, in this embodiment, when the ink jet printer 1 is switched on, or when an instruction to adjust the stop position of the carrier 41 is inputted by a user, the controller 7 calculates the difference between the actual stop position and the target stop position of the carrier 41 on the basis of the output from the encoder 50, changes the integral gain value which is used for controlling the carrier drive motor 42 according to the difference, and reflects the changed value in controlling the stop position of the carrier 41. In the ink jet printer 1 of this embodiment, the controller 7 carries out a PI (Proportional plus Integral) control on the carrier drive motor 42, and it enables a precise stop of the carrier 41 at the target stop position by optimizing appropriately the integral gain value, which is highly correlated with the stop position of the carrier 41, in parameters used for this PI control (a proportional gain value and an integral gain value).

FIG. 3 shows a difference [symbol] between the actual stop position and the target stop position of the carrier 41 when an amount of remaining ink or inks in the ink cartridge or ink cartridges 40 is small. The controller 7 calculates the difference [symbol] according to the following procedure, for example. Firstly, the controller 7 applies predetermined driving voltage to the carrier drive motor 42 so as to move the carrier 41 at a predetermined speed. Subsequently, the controller 7 applies a predetermined brake voltage to the carrier drive motor 42 so as to stop the carrier 41 at the target stop position. A speed reduction rate of the carrier 41 when the brake voltage is applied to the carrier drive motor 42 varies according to the remaining amount of the ink or inks and a temperature of the carrier drive motor 42. When the ink cartridge is or the ink cartridges are almost empty, the brake works more excessively in comparison with the ink cartridge or ink cartridges in normal condition, for example. When the brake works excessively on the carrier 41 as described above, the carrier 41 stops the difference [symbol] short of its target stop position, as shown in FIG. 3. At this time, the difference [symbol] is calculated from the controller 7 on the basis of the pulse signals which are outputted from the encoder 50.

An integral control included in the PI control is described below. The integral gain value used when the controller 7 carries out the integral control on the carrier drive motor 42 is stored in the memory 8.

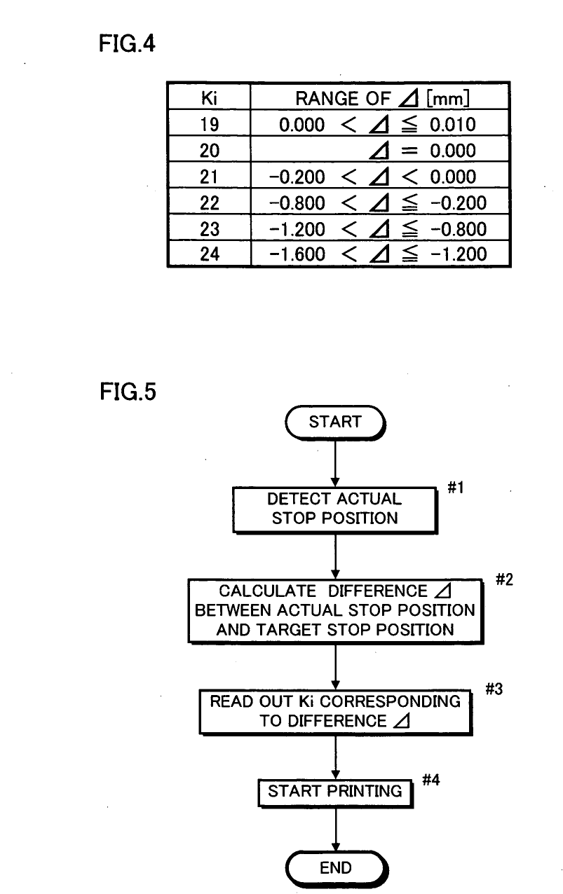

FIG. 4 shows several integral gain values Ki which are stored in the memory 8, together with the differences [symbol] . Each integral gain value Ki is stored in the memory 8 so as to correlated with each difference [symbol] . Hereupon, each integral gain value Ki correlated with each difference [symbol] indicates an integral gain value with which the controller 7 multiplies a motor control signal so as to minimize the difference [symbol] between the actual stop position and the target stop position calculated by the controller 7 on the basis of the pulse signals which are outputted from the encoder 50. For example, in case of 0.000 mm<the difference [symbol] ≦0.010 mm, the controller 7 multiplies the motor control signal with the integral gain value Ki=19. Moreover, in case of the difference [symbol] =0, the controller 7 multiplies the motor control signal with the integral gain value Ki=20. Furthermore, in case of −0.200 mm<the difference [symbol] <0.000 mm, the controller 7 then multiplies the motor control signal with the integral gain value Ki=21 (similar hereinafter). In case that the carrier 40 stops short of its target stop position, the difference [symbol] takes a negative value.

A process in the controller 7 in case of changing the integral gain value is described below, with reference to FIG. 5. Firstly, the controller 7 detects the actual stop position through the encoder 50 (step #1), and then, it calculates the difference [symbol] between the actual stop position and the target stop position (step #2). Subsequently, the controller 7 reads out the integral gain value Ki in the several integral gain values Ki stored in the memory 8 (step #3), drives the carrier drive motor 42 by multiplying the motor control signal by the integral gain value Ki, and starts printing (step #4).

As described above, according to the ink jet printer 1 of this embodiment, the memory 8 stores each integral gain value Ki so as to correspond to each difference [symbol] between the actual stop position and the target stop position of the carrier 41, the controller 7 calculates each difference [symbol] between the actual stop position and the target stop position of the carrier 41 which is detected by the encoder 50, and then controls the carrier drive motor 42 with referring the appropriate integral gain value Ki in the integral gain values Ki stored in the memory 8. Consequently, the carrier drive motor 42 can be controlled at the integral gain value Ki which always minimizes the difference [symbol] between the actual stop position and the target stop position of the carrier 41, and the accuracy of the actual stop position of the carrier 41 can be enhanced with using the inexpensive DC motor for the carrier drive motor 42. Moreover, the process described above is carried out after replacing the ink cartridge 40 with new one or when the instruction to adjust the stop position of the carrier 41 is inputted by the user, thus even if the remaining amount of the ink or inks in the ink cartridge or ink cartridges 40 varies, it becomes possible to make the carrier 41 stop nearly at the target stop position, and the print quality of the ink jet printer 1 can be improved.

The present invention is not limited to the composition of the preferred embodiment described above, however any composition is applicable, so long as the controller 7 controls the carrier drive motor 42 with using the integral gain value Ki corresponding to the calculated difference [symbol] .

Furthermore, in the above mentioned description, the ink cartridge having the recording head is exemplified. The present invention is applicable to the ink jet printer that the recording head is provided on the carrier.

This application is based on Japanese patent application 2005-347529 filed Dec. 1, 2005 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. An image forming apparatus comprising:
a carrier which holds at least one ink cartridge and reciprocally moves in a first direction;
a conveyor for conveying a recording paper sheet in a second direction perpendicular to the first direction;
a recording head provided on the carrier or the ink cartridge for discharging ink drops of an ink stored in the ink cartridge toward the recording paper sheet conveyed in the second direction to form an image on the recording paper sheet while the carrier with the ink cartridge is reciprocally moved in the first direction;
a DC motor which drives the carrier so as to reciprocally move in the first direction;
a drive transmission mechanism which transmits a drive force of the DC motor to the carrier;
an encoder which detects a position of the carrier driven in the first direction;
a controller which controls the DC motor based on signals outputted from the encoder; and
a memory which stores parameters referred when the motor control means controls the DC motor, wherein
the controller further detects an actual stop position of the carrier based on the signals outputted from the encoder, calculates a difference between the actual stop position and a target stop position of the carrier, and varies a parameter, which is used for controlling the DC motor, according to the difference, and thereby, stopping the carrier substantially at the target stop position.

2. The image forming apparatus in accordance with claim 1, wherein
the parameter is an integral gain value multiplied by a motor control signal.

3. The image forming apparatus in accordance with claim 2, wherein
the memory stores a plurality of the integral gain values corresponding to the values of the difference between the actual stop position and the target stop position of the carrier, and
the controller selects one integral gain value among the integral gain values stored in the memory corresponding to the calculated value the difference between the actual stop position and the target stop position of the carrier.

4. The image forming apparatus in accordance with claim 1, wherein
when the ink jet printer is switched on, or when an instruction to adjust the stop position of the carrier is inputted by a user, the controller calculates the difference between the actual stop position and the target stop position of the carrier based on the signals outputted from the encoder, and varies the parameter.

5. An image forming apparatus comprising:
an ink cartridge or ink cartridges to which at least one ink is filled, each;
a carrier which holds the ink cartridge or ink cartridges and reciprocally moves in a first direction;
a carrier drive motor of a DC motor which drives the carrier so as to move reciprocally in the first direction;
a drive transmission mechanism which transmits a drive force of the carrier drive motor to the carrier;
an encoder which detects a position of the carrier driven in the first direction;
a conveyor for conveying a recording paper sheet in a second direction perpendicular to the first direction;
a recording head provided on the carrier or the ink cartridge for discharging ink drops of an ink or inks stored in the ink cartridge or ink cartridges toward the recording paper sheet conveyed in the second direction to form an image on the recording paper sheet while the carrier with the ink cartridge is reciprocally moved in the first direction;
a carrier position detecting means which detects a position of the carrier based on signals outputted from the encoder;
a difference calculating means which calculates a difference between an actual stop position and a target stop position of the carrier based on detection result of the carrier position detecting means;
a memory means which stores a plurality of integral gain values and differences between an actual stop position and a target stop position of the carrier so as to corresponding to each other;
a carrier drive motor control means which selects one integral gain value among the integral gain values stored in the memory means corresponding to the calculated value the difference between the actual stop position and the target stop position of the carrier, multiplies a motor control signal bay the selected integral gain value, and drives the carrier drive motor with the multiplied motor control signal for enabling the difference between the actual stop position and the target stop position minimize, when the ink jet printer is switched on, or when an instruction to adjust the stop position of the carrier is inputted by a user.

6. An ink jet printer comprising:
a DC motor which drives a carrier in a main scanning direction;
an encoder which detects a position of the carrier in the main scanning direction;
a controller which controls the DC motor based on signals outputted from the encoder; and
a memory which stores parameters used for driving the DC motor by the controller, wherein
when the ink jet printer is switched on, or when an instruction to adjust the stop position of the carrier is inputted by a user, the controller detects an actual stop position of the carrier based on the signals outputted from the encoder, calculates a difference between the actual stop position and a target stop position of the carrier, and varies a parameter, which is used for controlling the DC motor, according to the difference, and thereby, stopping the carrier substantially at the target stop position.

7. The image forming apparatus in accordance with claim 6, wherein
the parameter is an integral gain value multiplied by a motor control signal.

8. The image forming apparatus in accordance with claim 7, wherein
the memory stores a plurality of the integral gain values corresponding to the values of the difference between the actual stop position and the target stop position of the carrier, and
the controller selects one integral gain value among the integral gain values stored in the memory corresponding to the calculated value the difference between the actual stop position and the target stop position of the carrier.
